(19) United States
(12) Patent Application Publication
(10) Pub. No.: US 2017/0130503 A1
(43) Pub. Date: May 11, 2017

(54) APPARATUS AND METHOD FOR SECURING A CASE TO A COMPONENT

(71) Applicant: Inteva Products, LLC, Troy, MI (US)

(72) Inventors: Geoffrey Barr, Troy, MI (US); Lisa Hopman, Oxford, MI (US); Michael Skiba, Sterling Heights, MI (US)

(21) Appl. No.: 14/936,030

(22) Filed: Nov. 9, 2015

(51) Int. Cl. E05F 5/00; E05F 11/53; F16M 13/02

(52) U.S. Cl. CPC E05F 5/003; F16M 13/02; E05F 11/535; E05Y 2900/531; B60J 1/08

(57) ABSTRACT

A bracket of a window regulator is provided. The bracket having: a first securement feature integrally formed with the bracket for securing a clutch housing to the bracket; and a second securement feature for locking the first securement feature in engagement with the clutch housing, wherein the second securement feature is integrally formed with the bracket.

### BACKGROUND

This invention relates to an apparatus and method for securing a case or case assembly to a component. More particularly, various embodiments of the present invention may be directed to an apparatus and method for securing a clutch case assembly to a bracket of a window regulator.

In a vehicle side door manual window regulator, there is a clutch case assembly to prevent reversal of the window, which is attached to the supporting structure. In the case of a plastic support, the current state of the art is to engage and retain the clutch case to the supporting plastic bracket. In some instances separate secondary components are used to secure the case to the bracket. This adds complexity and thus cost to the assembly as well as a potential failure point.

Accordingly, it is desirable to provide an improved apparatus and/or method for securing a case to a bracket.

### SUMMARY OF THE INVENTION

In one embodiment, a bracket of a window regulator is provided. The bracket having: a first securement feature integrally formed with the bracket for securing a clutch housing to the bracket; and a second securement feature for locking the first securement feature in engagement with the clutch housing, wherein the second securement feature is integrally formed with the bracket.

In addition to one or more of the features described above, or as an alternative to any of the foregoing embodiments, the bracket may be formed from plastic.

In addition to one or more of the features described above, or as an alternative to any of the foregoing embodiments, the first securement feature may include a pair of arm members integrally formed with the bracket via a living hinge and wherein the second securement feature is a pair of locking members that are integrally formed with bracket via a living hinge.

In addition to one or more of the features described above, or as an alternative to any of the foregoing embodiments, the bracket may further include a plurality of locating features that are received within complementary openings of clutch housing when the clutch housing is secured to the bracket.

In addition to one or more of the features described above, or as an alternative to any of the foregoing embodiments, the clutch housing secures a clutch assembly to the bracket.

In addition to one or more of the features described above, or as an alternative to any of the foregoing embodiments, the first securement feature engages a peripheral edge portion of the clutch housing when it is secured to bracket and wherein the second securement feature engages the first securement feature when the clutch housing is secured to the bracket by the first securement feature.

In addition to one or more of the features described above, or as an alternative to any of the foregoing embodiments, the first securement feature may include a pair of arm members integrally formed with the bracket via a living hinge and wherein the second securement feature is a pair of locking members that are integrally formed with bracket via a living hinge and wherein each arm member has a feature with an inclined surface that terminates at a first ledge portion that is configured to engage a peripheral edge portion of the clutch housing when it is secured to bracket.

In addition to one or more of the features described above, or as an alternative to any of the foregoing embodiments, each arm member may further include a second inclined surface that terminates at a second ledge portion that is configured to engage a distal end of the pair of locking members.

In addition to one or more of the features described above, or as an alternative to any of the foregoing embodiments, the second inclined surface and the second ledge portion may be located on an opposite side of the arm members with respect to the first inclined surface and the first ledge portion.

In yet another embodiment, a method of securing a housing to a bracket is provided. The method including the steps of: sliding a peripheral edge portion of the housing past a first securement feature integrally formed with the bracket; and engaging the first securement feature with a second securement feature when the first securement feature has engaged the peripheral edge portion.

In addition to one or more of the features described above, or as an alternative to any of the foregoing embodiments, the bracket may be formed from plastic.

In addition to one or more of the features described above, or as an alternative to any of the foregoing embodiments, the first securement feature may further include a pair of arm members integrally formed with the bracket via a living hinge and wherein the second securement feature is a pair of locking members that are integrally formed with bracket via a living hinge.

In addition to one or more of the features described above, or as an alternative to any of the foregoing embodiments, the bracket may further include a plurality of locating features that are received within complementary openings of clutch housing when the clutch housing is secured to the bracket.

In addition to one or more of the features described above, or as an alternative to any of the foregoing embodiments, the first securement feature may further include a pair of arm members integrally formed with the bracket via a living hinge and wherein the second securement feature is a pair of locking members that are integrally formed with bracket via a living hinge and wherein each arm member has a feature with an inclined surface that terminates at a first ledge portion that is configured to engage a peripheral edge portion of the clutch housing when it is secured to bracket.

In addition to one or more of the features described above, or as an alternative to any of the foregoing embodiments, each arm member may further include a second inclined surface that terminates at a second ledge portion that is configured to engage a distal end of the pair of locking members.

In addition to one or more of the features described above, or as an alternative to any of the foregoing embodiments, the second inclined surface and the second ledge portion are located on an opposite side of the arm members with respect to the first inclined surface and the first ledge portion.

In addition to one or more of the features described above, or as an alternative to any of the foregoing embodiments, the clutch housing may be secured to the bracket via a single stroke of the bracket with respect to a fixture.

In addition to one or more of the features described above, or as an alternative to any of the foregoing embodiments, the fixture may have a movable member slidably received within an opening of the fixture.

In addition to one or more of the features described above, or as an alternative to any of the foregoing embodiments, the movable member may be spring biased away from the fixture.

In yet another embodiment, a window regulator for a vehicle is provided, the window regulator having: a clutch assembly, the clutch assembly having a clutch housing; and a plastic bracket having a first securement feature integrally formed with the plastic bracket and a second securement feature integrally formed with the plastic bracket, wherein the first securement feature and the second securement feature are configured to secure the clutch housing to the bracket via a single assembly step.

In yet another embodiment, a component is provided. The component having: a first securement feature integrally formed with the component for securing a housing to the component; and a second securement feature for locking the first securement feature in engagement with the housing, wherein the second securement feature is integrally formed with the component.

### BRIEF DESCRIPTION OF THE DRAWINGS

Other features, advantages and details appear, by way of example only, in the following description of embodiments, the description referring to the drawings in which:

FIG. 1 is an exploded perspective view of a clutch assembly for securement to a bracket in accordance with one non-limiting exemplary embodiment of the present invention;

FIGS. 2 and 3 are perspective views of the bracket and its securement features in accordance with various embodiments of the present invention;

FIG. 4 is a cross-sectional view of the bracket and its integral securement features in accordance with various embodiments of the present invention;

FIGS. 5 and 6 are cross-sectional views illustrating securement of the clutch housing to the bracket in accordance with various embodiments of the present invention;

FIG. 7 is view of a housing secured to component in accordance with an alternative embodiment of the present invention;

FIG. 7A is a view along lines 7A-7A of FIG. 7; and

FIG. 8 is a partial perspective view of the housing illustrated in FIG. 7.

Although the drawings represent varied embodiments and features of the present invention, the drawings are not necessarily to scale and certain features may be exaggerated in order to illustrate and explain exemplary embodiments of the present invention. The exemplification set forth herein illustrates several aspects of the invention, in one form, and such exemplification is not to be construed as limiting the scope of the invention in any manner.

### DETAILED DESCRIPTION

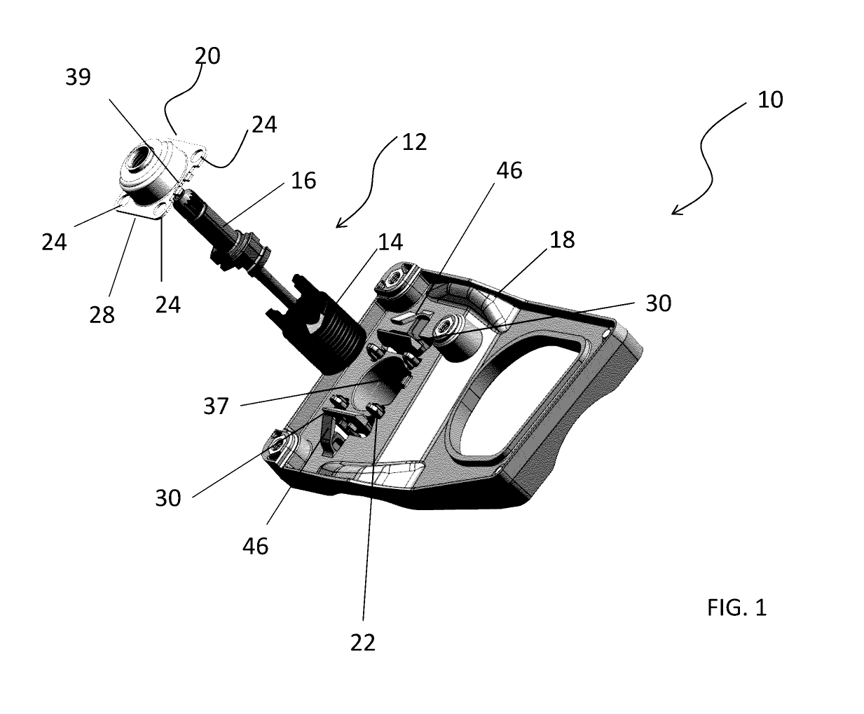

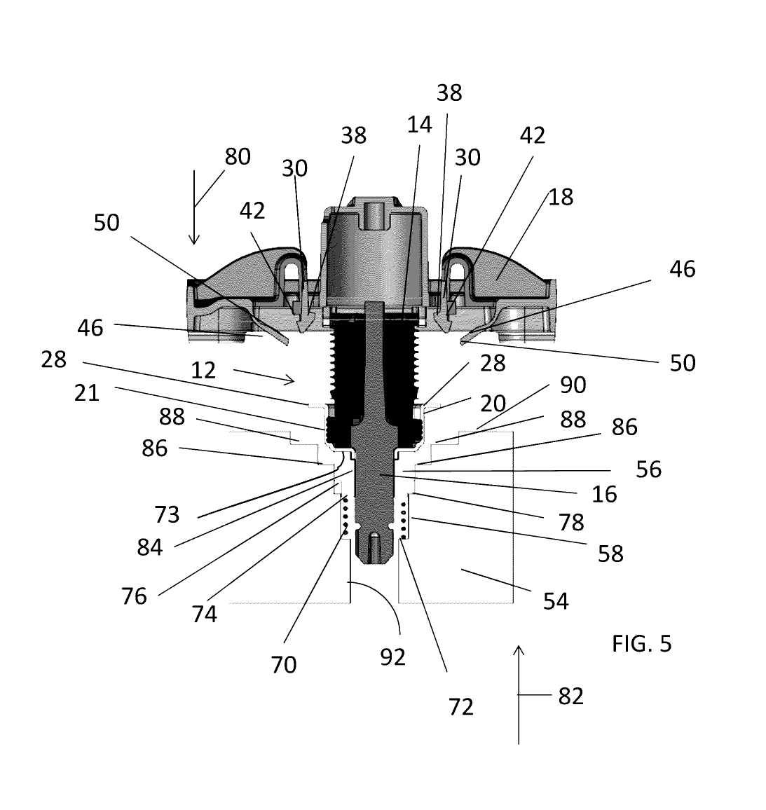

Turning now to the drawings, wherein to the extent possible like reference numerals are utilized to designate like components throughout the various views, in FIG. 1 a portion of a window regulator 10 is illustrated. In one non-limiting embodiment window regulator 10 is configured for use with a manual window regulator for a side door of a vehicle. As mentioned above, it is desirable to have a clutch assembly in order to prevent undesired motion of the window and allow motion only when the window regulator is operated manually via a crank attached to a spindle 16. A portion of such a clutch assembly 12 is illustrated in FIG. 1. In one embodiment, the clutch assembly 12 includes a drum or cable spool 14 that is rotatably received on a spindle 16, a housing 20 and an internal spring 21 (FIG. 5). In accordance with various embodiments of the present invention the clutch assembly 12 is secured to a bracket or housing 18 of the window regulator 10. In one non-limiting embodiment, the bracket 18 is formed out of an easily moldable material such as plastic.

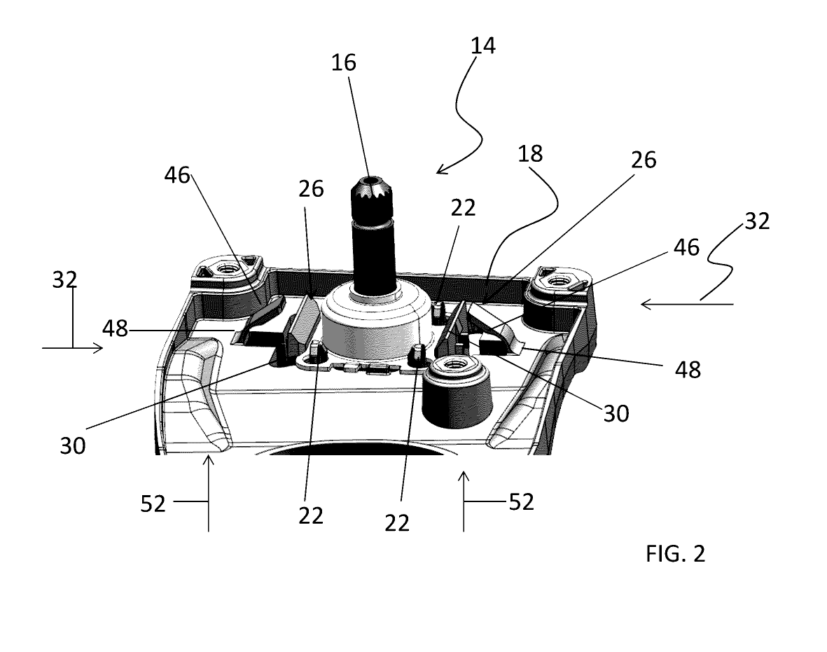

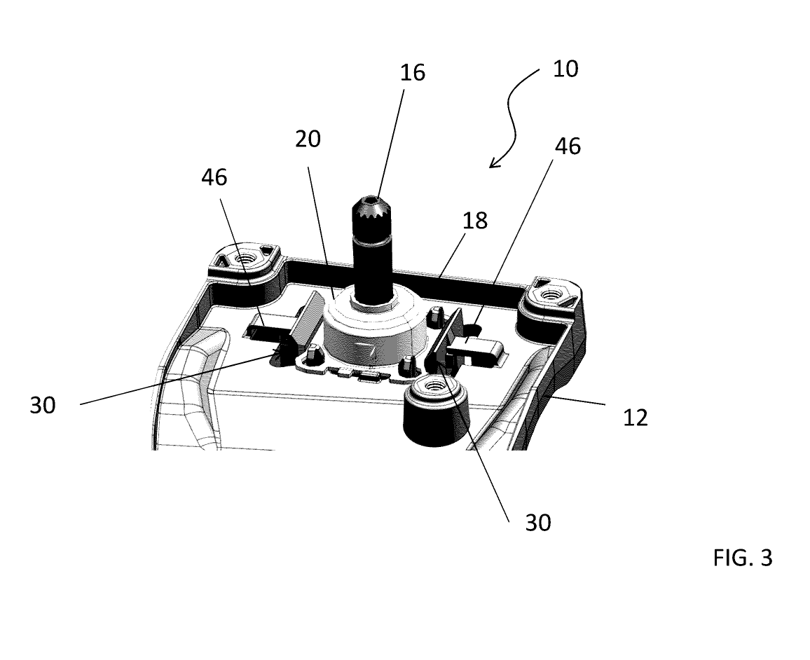

In order to secure the clutch assembly 12 to the bracket 18 the clutch housing 20 is secured to bracket 18 via a unique assembly and retention process in accordance with various embodiments of the present invention. Referring now to FIGS. 2 and 3, the clutch housing 20 is shown as being secured to bracket 18. In FIG. 2, the clutch housing 20 is positioned on bracket 18 wherein a plurality of locating features 22 are received within complementary openings 24 of clutch housing 20.

In addition, a first securement feature 26 engages a peripheral edge portion 28 of the clutch housing when it is secured to bracket 18. In one embodiment, the first securement feature 26 is a pair of arm members 30 that are integrally formed with bracket 18 such that distal end portions thereof are biased in the direction of arrows 32 into the position illustrated in the attached FIGS. In one embodiment, each arm member 30 has a feature 34 with an inclined surface 36 that terminates at a first ledge portion 38 which is configured to engage peripheral edge portion 28 of the clutch housing 20 when it is secured to bracket 18. In addition, feature 34 is also configured to have a second inclined surface 40 that terminates at a second ledge portion 42 which provides portions of a second securement feature 44 for securing the clutch housing 20 to the bracket 18. The second inclined surface 40 and the second ledge portion 42 are located on an opposite side of the arm members 30 with respect to the first inclined surface 36 and the first ledge portion 38. In another non-limiting embodiment, a protrusion or feature 37 is provided to be received in an opening or slot 39 in order to orientate the housing 20 in a desired location when it is placed on or secured to bracket 18.

The second securement feature 44 includes a pair of locking members 46 that are integrally formed with bracket 18 and secured thereto via a living hinge 48 such that locking members 46 may be used to provide a locking feature or second securement feature 44 in accordance with various embodiments of the present invention. Accordingly, the first securement feature(s) 26 provide a means for retaining clutch housing 20 to bracket 18 while the second securement feature(s) 44 provide a means for locking the first securement feature(s) 26 in their engaged position with respect to clutch housing 20. Still further and as will be discussed herein, the first and second securement features 26, 44 are engaged with a single stroke of movement of the clutch housing 20 with respect to the bracket 18.

The pair of arm members 30 are also secured to bracket 18 via a living hinge 49 such that as the clutch housing 20 is secured to the bracket 18 when the peripheral edge portion 28 of the clutch housing slides along inclined surface 36 and biases the pair of arm members 30 outwardly in a direction opposite to the biasing force in the direction of arrows 32 such that peripheral edge portion 28 can pass by ledge 38 and thus be engaged by the pair of arm members 30 after they are returned to their first or initial position illustrated in the attached FIGS., wherein ledge 38 engages a portion of peripheral edge portion 28.

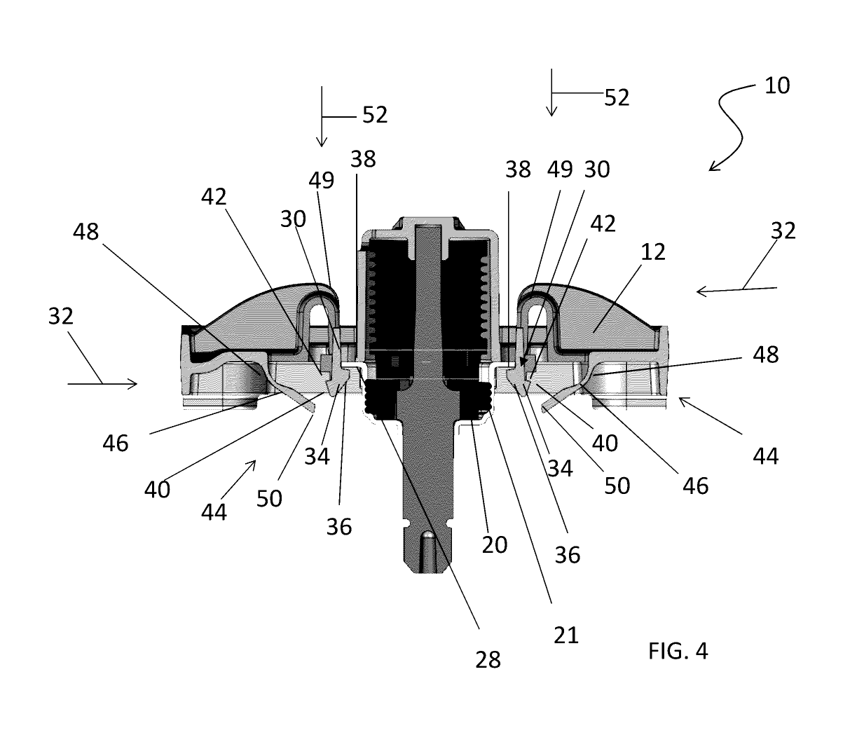

Thereafter, the locking members 46 are pushed downwardly towards the bracket 18 such that a distal end 50 of the locking members 46 slides along angled surface 40 until it passes ledge 42 and is thus retained therein via ledge 42. It being understood that the living hinge 48 provides a biasing force in the direction of arrows 52 such that the locking members 46 are biased into a first position illustrated in at least FIGS. 1, 2, 4 and 5. In addition and in order to allow for the distal ends 50 of the locking members 46 to pass surface 40 and engage ledge 42, the first position of arm members 30 will allow for a slight movement in the direction of arrows 32 in order to allow distal end 50 to pass by ledge 42. In addition, ledge 38 will be large enough to allow for this movement while also retaining clutch housing 20 to bracket 18. In addition, the ledge portion 28 will also be configured to allow for this slight movement of arm members 30 in order to allow for locking members 46 to engage ledge 42 thereby locking arm members 30 in their engaged position with respect to clutch housing 20.

FIG. 2 illustrates the arm members 30 in their first position wherein ledge 38 has engaged a portion of the peripheral edge portion 28 of clutch housing 20. In FIG. 2, the locking members 46 are in their respective first positions as they have not been moved towards the housing 12 against their biasing force in the direction of arrows 52 via living hinge 48. FIG. 3 illustrates the locking members 46 being positioned into a second position such that distal end 50 engages ledge 42 and thus clutch housing 20 is secured to bracket 18. Once the locking members 46 are in the second position, arm members 30 are fixedly retained or locked in their engaged position with respect to housing 20 such that it cannot be removed from bracket 18.

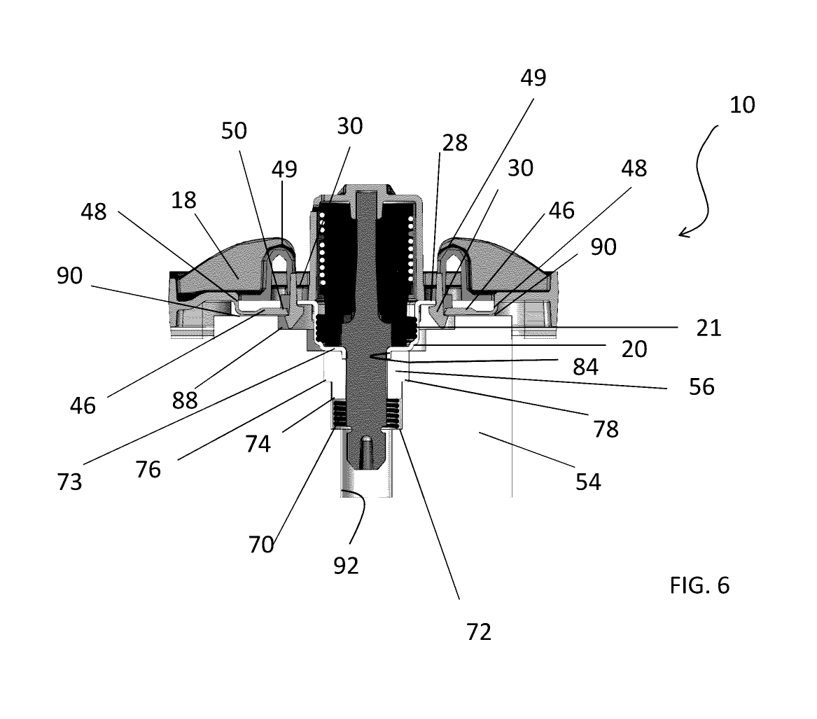

Referring now to FIGS. 5 and 6, the securement of clutch housing 20 to bracket 18 is illustrated. As shown in FIG. 5, the spindle 16 and drum or cable spool 14 are inserted into clutch housing 20 to create a portion of the clutch assembly 12. Also illustrated in FIGS. 5 and 6 is a fixture 54 configured for mounting clutch housing 20 and clutch assembly 12 to bracket 18. The fixture 54 includes a movable member 56 slidably received within an opening 58 of the fixture 54. A spring 70 is provided to engage a ledge portion 72 of the fixture 54 and a surface 74 of the movable member 56 thereby providing a biasing force to movable member 56. Movable member 56 also includes a ledge portion 76 that is configured to stop or engage a ledge portion 78 of fixture 54 when spring 70 is compressed via movement of the bracket 18 downwardly in the direction of arrow 80. Accordingly, spring 70 provides a biasing force in the direction of arrow 82 towards housing 20 when clutch assembly 12 is resting upon movable member 56.

Movable member 56 also has an inner opening 84 configured to slidably receive a portion of spindle 16. Also shown is that fixture 54 as a plurality of ledges 86, 88 and 90 which extend peripherally outwardly from an inner opening 92 of fixture 54. Accordingly and as bracket or housing 18 is moved downwardly in the direction of arrow 80, clutch housing 20 rests on a surface 73 of movable member 56, resulting in engagement of locating features 22 of bracket 18 into complementary openings 24 of clutch housing 20, thus guiding a further motion downwardly wherein the biasing force of spring 70 translates into deflection of arm members 30 of bracket 18, until ledges 38 engage peripheral edge portion 28. In a further movement downwardly in the direction of arrow 80, spring 70 is compressed until the ledge 76 of movable member 56 contacts ledge 78, which is illustrated in at least FIG. 6. The biasing force of moveable member 56 retains the clutch housing 20 in a position to keep the clutch assembly 12 together or assembled as it is secured to bracket 18. Simultaneously ledge 90 contacts a portion of locking members 46 and moves them against their biasing force from their first position to their second position wherein the distal ends 50 of the locking members 46 now engage ledges 42 of arm members 30 and thus lock them in an engaged position with respect to clutch housing 20. Ledges 86 and 88 are configured to allow movement of the clutch housing and the ends of the arm members 30 into fixture 54 such that ledges or surfaces 90 can contact locking members 46 and move them from their first position to their second position.

Accordingly in accordance with various environments of the present invention, a quick and efficient means for securing a clutch housing 20 to a bracket 18 of the window regulator 10 is provided. Moreover and through the use of integrally formed plastic arm members 30 as well as locking members 46, clutch housing 20 is fixedly secured to bracket 18 without requiring separate secondary components that add to part complexity and manufacturing costs. Still further, various embodiments of the present invention provide a unique means for securing the clutch housing 20 to bracket 18 with snap fitting engagement features with a living hinge design that allows the part to be easily molded with simple tooling and which is robustly retained in the final assembly.

The assembly process is also facilitated by being able to press the clutch case or housing 20 past the primary retainers for our members 30 and also engage the secondary locking features or locking members 46 with one continuous motion of the bracket or housing 18. Accordingly, the first and second securement features 26, 44 allow for a single stroke assembly process in one arbor press.

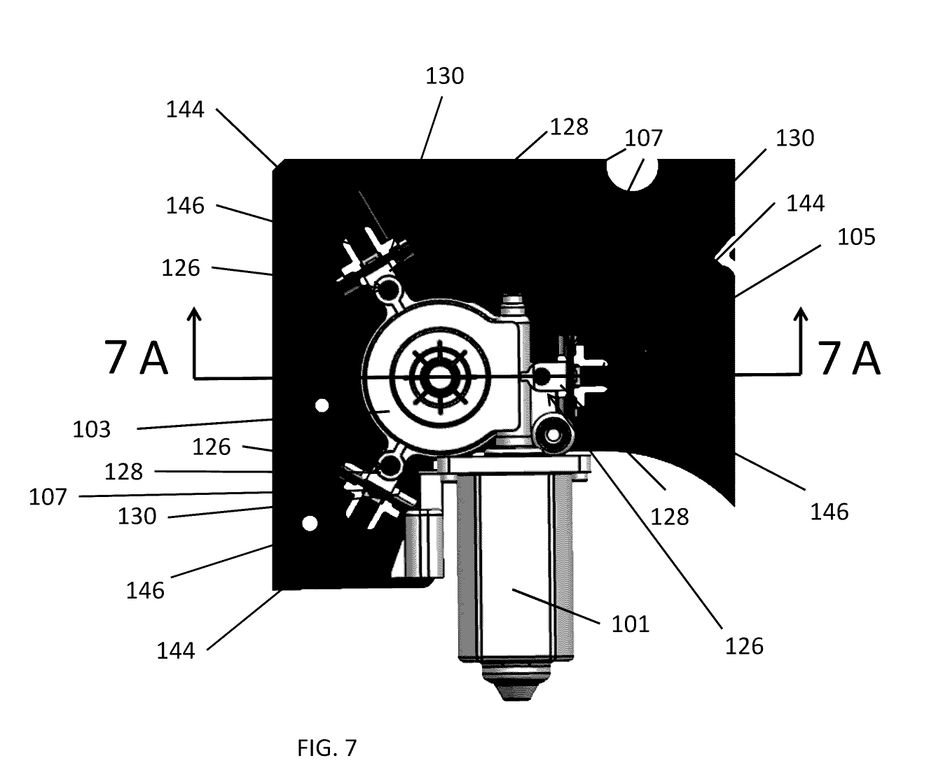

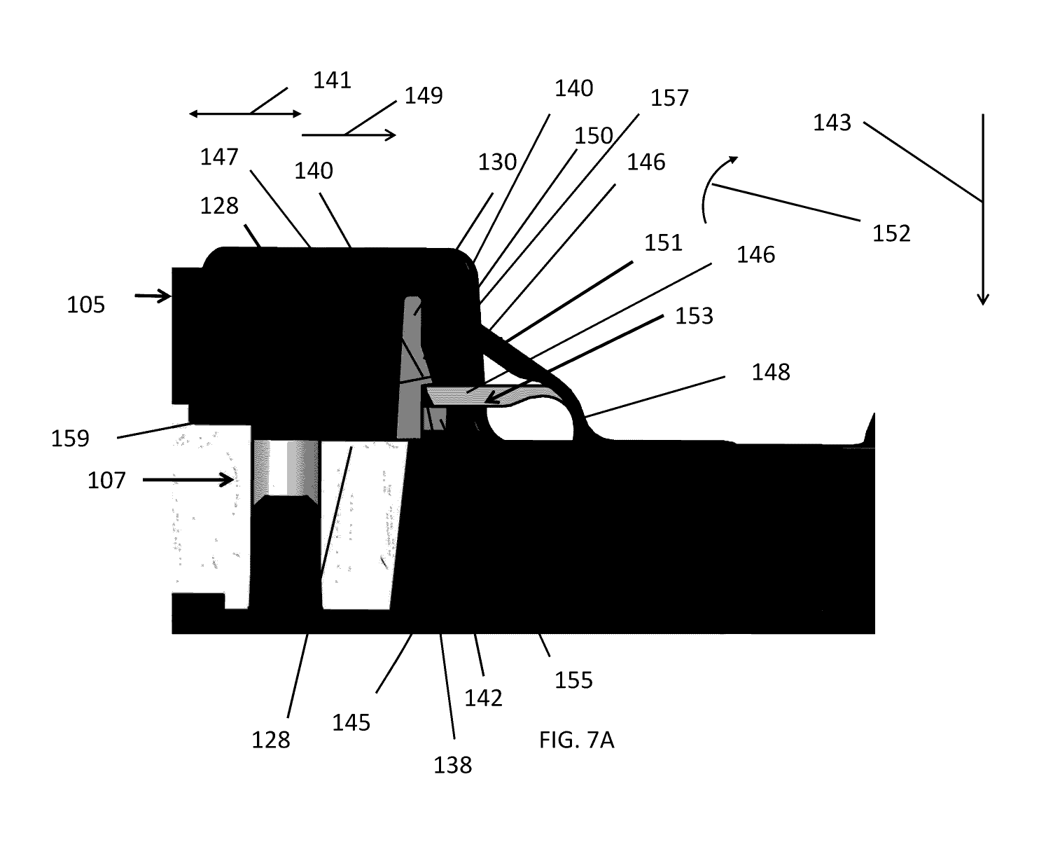

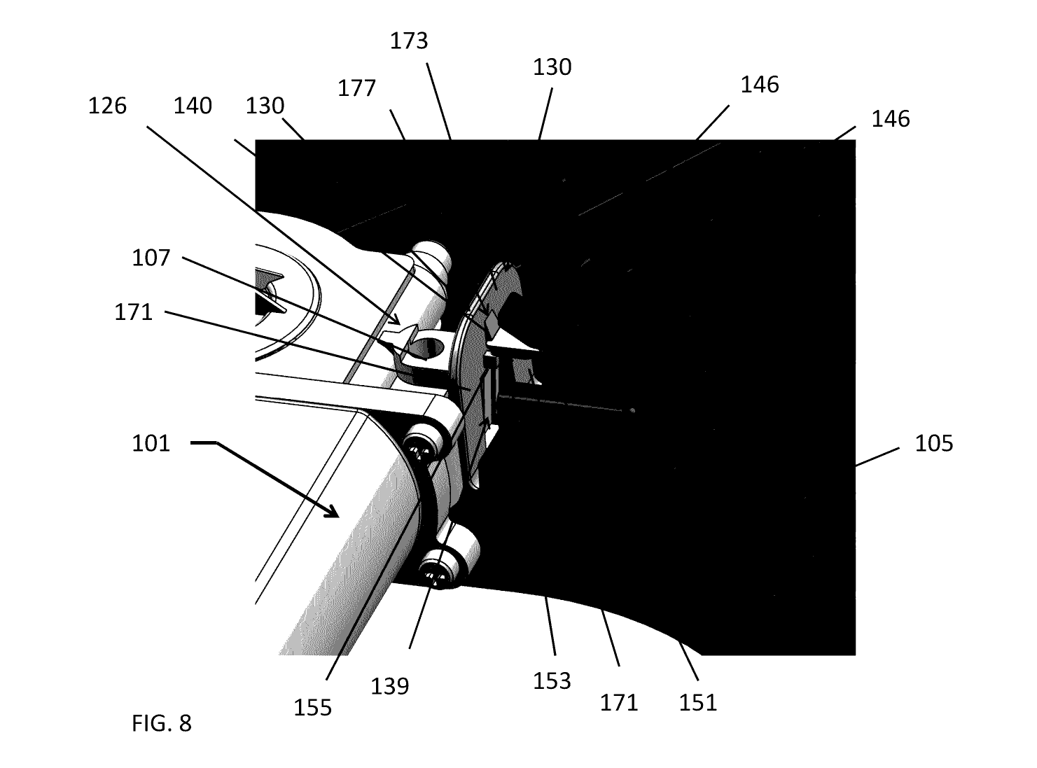

Referring now to FIGS. 7, 7A and 8, an alternative embodiment of the present invention is illustrated. In this embodiment, a motor or motor housing 101 and/or a housing portion 103 is secured to a frame, guide rail or component 105 of a vehicle component, which in one embodiment may be a guide rail of a window regulator. In one embodiment, the housing portion 103 is configured to receive and enclose a worm (not shown) of the motor and a cable drum (not shown) that is rotatably driven by the motor via the worm. As illustrated, the housing portion 103 may have a plurality of securement features 107 disposed about the periphery of the housing portion 103. Although three securement features 107 are illustrated any number greater or less than three is to be considered to be within the scope of various embodiments of the present invention.

The frame or guide rail 105 has a plurality of complimentary members 130 each having a surface 138 configured to cooperate with and contact a surface 128 of feature 107 when the housing portion 103 is secured to the frame or guide rail 105. In one embodiment, surface 138 is located in an opening 139 of member 130. In addition, members 130 are integrally formed with the frame or guide rail 105. For example, member 130 may have a pair of vertical arms 171 integrally formed with the guide rail or frame 105 at one end and an integral top portion 173 extending between the arms 171 such that opening 139 is defined by arms 171 and top portion 173.

In one embodiment, the members 130 may be formed from a resilient material such as plastic or metal or equivalents thereof such that members 130 may be moved in the directions of arrows 141 between a first position and a second position as housing portion 103 is inserted into a “snap fit” engagement with respect to the frame or guide rail 105. This is achieved by inserting the housing in the direction of arrow 143 with respect to frame or guide rail 105 until features 107 engage members 130. During this process, an angled surface 145 of the feature 107 slides along a surface 147 of the member 130 causing it to deflect outwardly in the direction of arrow 149 until surface 128 engages surface 138 of opening 139 (e.g., surface 128 or a portion thereof is received in opening 139). At this point, the member deflects back to its first unbiased position and surface 128 engages surface 138. The cooperation or engagement of member 130 with portion 107 may be referred to as a first securement feature(s) 126.

In order to prevent member 130 from being inadvertently deflected in the direction of arrow 149 after feature 107 has engaged member 130, a locking member 146 is provided. Locking members 146 are integrally formed with frame or rail 105 and are secured thereto via a living hinge 148 such that locking members 146 may be used to provide a locking feature or second securement feature 144 in accordance with various embodiments of the present invention.

Once surface 128 of feature 107 engages surface 138 of member 130, the associated locking member 146 is pushed downwardly from a first position 151 towards the frame or guide rail 105 such that a distal end 150 of the locking member 146 slides along angled surface 140 of a feature or protrusion 177 until it passes a ledge 142 of feature or protrusion 177 and is thus retained therein via ledge 142. At this point, the locking member 146 is in a second position 153. It being understood that the living hinge 148 provides a biasing force in the direction of arrows 152 such that the locking members 146 are biased into the first position 151 illustrated in at least FIGS. 7A and 8. In addition and in order to allow for the distal ends 150 of the locking members 146 to pass surface 140 and engage ledge 142, the first position of arm members 130 will allow for a slight movement in the direction of arrows 141 in order to allow distal end 150 to pass by ledge 142.

Also shown is that members 130 may be configured to further comprise a stop feature 155 located below ledge 142 and spaced therefrom such that movement of the distal end 150 of locking member 146 in the direction of arrow 143 is limited. In addition, distal end 150 may be configured to have an inclined surface 157 and feature 140 may also have an inclined surface 159 allowing distal end 150 to slide past feature 140 and engage ledge 142.

Accordingly, the first securement feature(s) 126 provide a means for retaining the housing 103 to the frame or guide rail or component 105 while the second securement feature(s) 144 provide a means for locking the first securement feature(s) 126 in their engaged position with respect to housing 103. Still further and as previously discussed herein, the first and second securement features 126, 144 may be engaged with a single stroke of movement of the housing 103 with respect to the guide rail or frame 105.

Although, FIGS. 7, 7A and 8 illustrate a housing 103 being secured to a frame or guide rail or component 105 various embodiments of the present invention may be used to attach or secured any items to another component via the first and second securement features 26, 126, 44, 144 as illustrated and described herein.

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation.

The modifier “about” used in connection with a quantity is inclusive of the stated value and has the meaning dictated by the context (e.g., includes the degree of error associated with measurement of the particular quantity).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the present application.

What is claimed is:

1. A bracket of a window regulator, comprising:
a first securement feature integrally formed with the bracket for securing a clutch housing to the bracket; and
a second securement feature for locking the first securement feature in engagement with the clutch housing, wherein the second securement feature is integrally formed with the bracket.

2. The bracket as in claim 1, wherein the bracket is formed from plastic.

3. The bracket as in claim 1, wherein the first securement feature comprises a pair of arm members integrally formed with the bracket via a living hinge and wherein the second securement feature is a pair of locking members that are integrally formed with bracket via a living hinge.

4. The bracket as in claim 1, wherein the bracket further comprises a plurality of locating features that are received within complementary openings of clutch housing when the clutch housing is secured to the bracket.

5. The bracket as in claim 1, wherein the clutch housing secures a clutch assembly to the bracket.

6. The bracket as in claim 1, wherein the first securement feature engages a peripheral edge portion of the clutch housing when it is secured to bracket and wherein the second securement feature engages the first securement feature when the clutch housing is secured to the bracket by the first securement feature.

7. The bracket as in claim 1, wherein the first securement feature comprises a pair of arm members integrally formed with the bracket via a living hinge and wherein the second securement feature is a pair of locking members that are integrally formed with bracket via a living hinge and wherein each arm member has a feature with an inclined surface that terminates at a first ledge portion that is configured to engage a peripheral edge portion of the clutch housing when it is secured to bracket.

8. The bracket as in claim 7, wherein each arm member further comprises a second inclined surface that terminates at a second ledge portion that is configured to engage a distal end of the pair of locking members.

9. The bracket as in claim 7, wherein the second inclined surface and the second ledge portion are located on an opposite side of the arm members with respect to the first inclined surface and the first ledge portion.

10. A method of securing a housing to a bracket, comprising:
sliding a peripheral edge portion of the housing past a first securement feature integrally formed with the bracket; and
engaging the first securement feature with a second securement feature when the first securement feature has engaged the peripheral edge portion.

11. The method as in claim 10, wherein the bracket is formed from plastic.

12. The method as in claim 11, wherein the first securement feature comprises a pair of arm members integrally formed with the bracket via a living hinge and wherein the second securement feature is a pair of locking members that are integrally formed with bracket via a living hinge.

13. The method as in claim 10, wherein the bracket 18 further comprises a plurality of locating features that are received within complementary openings of clutch housing when the clutch housing is secured to the bracket.

14. The method as in claim 10, wherein the first securement feature comprises a pair of arm members integrally formed with the bracket via a living hinge and wherein the second securement feature is a pair of locking members that are integrally formed with bracket via a living hinge and wherein each arm member has a feature with an inclined surface that terminates at a first ledge portion that is configured to engage a peripheral edge portion of the clutch housing when it is secured to bracket.

15. The method as in claim 14, wherein each arm member further comprises a second inclined surface that terminates at a second ledge portion that is configured to engage a distal end of the pair of locking members.

16. The method as in claim 15, wherein the second inclined surface and the second ledge portion are located on an opposite side of the arm members with respect to the first inclined surface and the first ledge portion.

17. The method as in claim 10, wherein the clutch housing is secured to the bracket via a single stroke of the bracket with respect to a fixture.

18. The method as in claim 17, wherein the fixture has a movable member slidably received within an opening of the fixture.

19. The method as in claim 18, wherein the movable member is spring biased away from the fixture.

20. A window regulator for a vehicle, comprising:
a clutch assembly, the clutch assembly having a clutch housing; and
a plastic bracket having a first securement feature integrally formed with the plastic bracket and a second securement feature integrally formed with the plastic bracket, wherein the first securement feature and the second securement feature are configured to secure the clutch housing to the bracket via a single assembly step.

21. A component, comprising:
a first securement feature integrally formed with the component for securing a housing to the component; and
a second securement feature for locking the first securement feature in engagement with the housing, wherein the second securement feature is integrally formed with the component.
